(19) United States
(12) Patent Application Publication
(10) Pub. No.: US 2005/0220319 A1
(43) Pub. Date: Oct. 6, 2005

(54) Earphones / earbuds

(76) Inventors: Eric Chan, New York, NY (US); Gary Natsume, Brooklyn, NY (US)

Correspondence Address: SUGHRUE MION, PLLC, 2100 PENNSYLVANIA AVENUE, N.W., SUITE 800, WASHINGTON, DC, 20037, US

(21) Appl. No.: 10/879,602

(22) Filed: Jun. 30, 2004

Related U.S. Application Data
(60) Provisional application No. 60/557,419, filed on Mar. 30, 2004.

(51) Int. Cl. H04R 25/00

(52) U.S. Cl. 381/374; 381/370; 381/384

(57) ABSTRACT

A set of earphones or earbuds used by audiophiles to listen to music or other types of audio information produced by equipment such as MP3 players, CD players, and the like. The earphones include a slider that encloses a pair of wires between a tail and a body of left and right earbuds. The slider can be situated to abut the tail or to slide and hold the left and right earbuds together.

### FIELD OF THE INVENTION

This invention relates to earphones or earbuds used by audiophiles to listen to music or other types of information produced by audio equipment such as MP3 players, CD players, and so on.

### BACKGROUND OF THE INVENTION

Conventional earphones are typically provided with two ends that become entangled and entrapped when not in use. Consequently, earphone users have found conventional devices to be frustrating when the earphones become entangled. Accordingly, there is a need for earphones that do not become entangled when in storage.

### SUMMARY OF THE INVENTION

In an illustrative, non-limiting implementation, earphones/earbuds are provided for listening to music or other types of information produced by audio equipment such as MP3 players, CD players, and so on. The earphones/earbuds include a sliding organizer that brings together the left and right earphones when not in use, preventing entanglement.

### BRIEF DESCRIPTION OF THE DRAWINGS

FIG. 1 illustrates an embodiment of the earphones as provided by the present invention, showing a sliding organizer “docked” on a tail portion of the earphones/earbuds;

FIG. 2 shows an embodiment of the earphones as provided by the invention, showing a sliding organizer “docked” on the left and right speaker capsules, thereby preventing entanglement; and

FIGS. 3A and 3B illustrate a connector plug as part of the earphones of the present invention.

### DETAILED DESCRIPTION OF PREFERRED EMBODIMENTS OF THE INVENTION

The following description of illustrative, non-limiting embodiments of the invention discloses specific configurations and components. However, the embodiments are merely examples of the present invention; and thus, the specific features described below are used to describe more easily such embodiments and to provide an overall understanding of the present invention. Accordingly, a skilled artisan will readily recognize that the present invention is not limited to the specific embodiments described below. Furthermore, the descriptions of various configurations and components of the present invention that are known to the ordinarily skilled artisan are omitted for the sake of clarity and brevity.

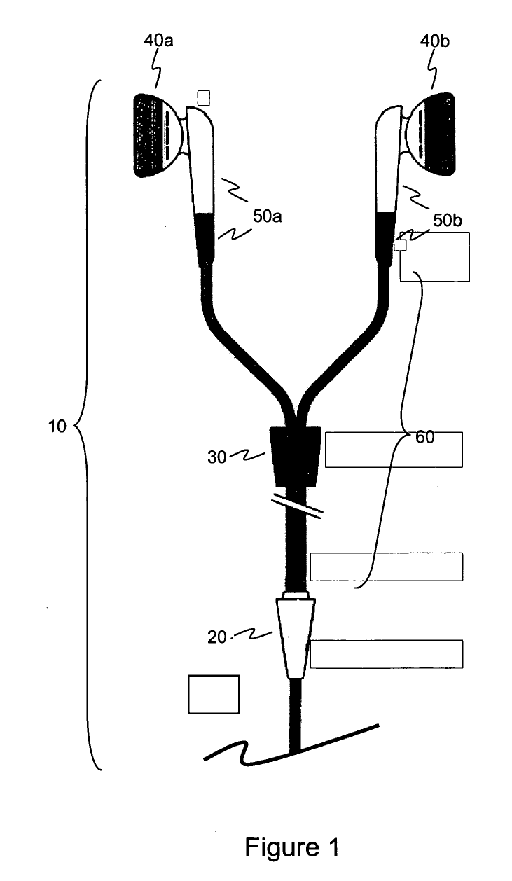

FIG. 1 shows an illustrative, exemplary embodiment of the present invention including earphones/earbud body 10. Earphones/earbud body 10 comprises: speaker cord 60, organizer docking tail 20, sliding organizer 30, left speaker capsule 40a, right speaker capsule 40b, left speaker capsule body 50a, and right speaker capsule body 50b. The sliding organizer 30 is enabled to articulate between a location on the organizer docking tail 20 and the right and left speaker capsule bodies 50a and 50b along the speaker cord 60.

The sliding organizer 30 is capable of docking to the organizer docking tail 20 (thus allowing the two separable ends of the speaker cord 60 to separate) or being slid along the speaker cord 60 to dock at the other end of the earphones/earbud body 10 on the left and right speaker capsule bodies 50a and 50b (thus bringing the separable ends of speaker cord 60 together so the invention may be stored in an organized manner). The sliding organizer 30 may be made of plastic, rubber, metal, or known materials in the art so long as the sliding organizer 30 provides smooth articulation of movement up and down the dual speaker cord 60, thereby enabling the dual speaker cord 60 to articulate together or apart as further explained herein.

Each of the separable ends of the speaker cord 60 has dual speaker wires contained in a grounding mesh or other insulative shielding covered by a plastic or cloth outer layer. The outer layer may also be rubber. A feature provided by the speaker cord 60 in conjunction with the sliding organizer 30 is that the two are of such material that the sliding organizer 30 and the speaker cord 60 do not become bound upon one another as the sliding organizer 30 is slid along the speaker cord 60 to “dock” at either end. In various embodiments, the sliding organizer 30 is grooved and/or notched and/or tapered so as to audibly, yet smoothly, dock and connect to either of the tail 20 and the left/right speaker capsule bodies 50a/b.

According to one embodiment, the sliding organizer 30 is plastic, while the outer sheath of the speaker cord 60 is cloth, thereby enabling smooth sliding of the sliding organizer 30 from the docking tail 20 to the right and left speaker capsule bodies 50a and 50b. The left speaker capsule body 50a and right speaker capsule body 50b may be composed of plastic or rubber or other known materials. The left speaker capsule body 50a and right speaker capsule body 50b are tapered to provide a smooth docking position when the sliding organizer 30 is slid onto the left ear capsule body 50a and right ear capsule body 50b.

The sliding organizer 30 docks onto one of the docking tail 20 and/or the left/right speaker capsule bodies 50a/b by “clicking” into place, thereby letting a user know through an audible indicator that the sliding organizer 30 is in place.

The left capsule 40a and right capsule 40b each contain speakers that a user would position in one's ears to listen to music or other audible information produced by audio equipment such as MP3 players, CD players, and so on. The left and right capsules 40a and 40b may include ear caps made of silicon, rubber or other soft material for comfortable wearing by a user. The left capsule and right capsule 40a and 40b each contain a speaker that the user uses to listen to music or other audio information. The speakers are each connected to two conductive wires and a shielding mesh/ground conductor in the left and right capsules 40a and 40b, the two conductive wires and shielding mesh/ground conductor being provided by the speaker cord 60. The shielding mesh/ground conductor, as one of ordinary skill in the art would understand, and as provided in speaker cord 60, is attached to additional shielding means within the speaker to help prevent interference from electromagnetic interference or electromagnetic disturbance.

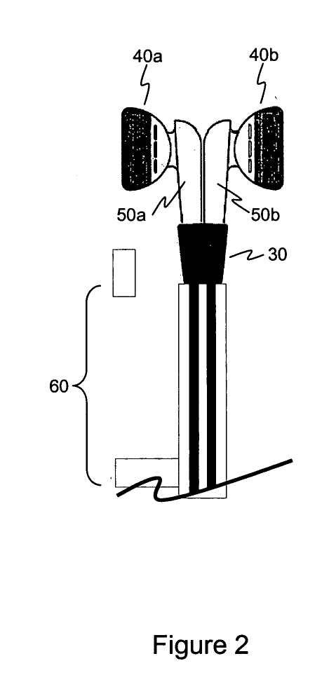

FIG. 2 shows another exemplary embodiment of the present invention wherein the left capsule 40a and right capsule 40b have been brought together by the sliding organizer 30 sliding onto the left capsule body 50a simultaneously with the right capsule body 50b. As shown in FIG. 2, by sliding the sliding organizer 30 on to the left capsule body 50a and right capsule body 50b, the speaker cord 60 is brought together in an organized fashion. This is so that when a user, having finished listening to their audio information, can easily store the earphones/earbud body 10.

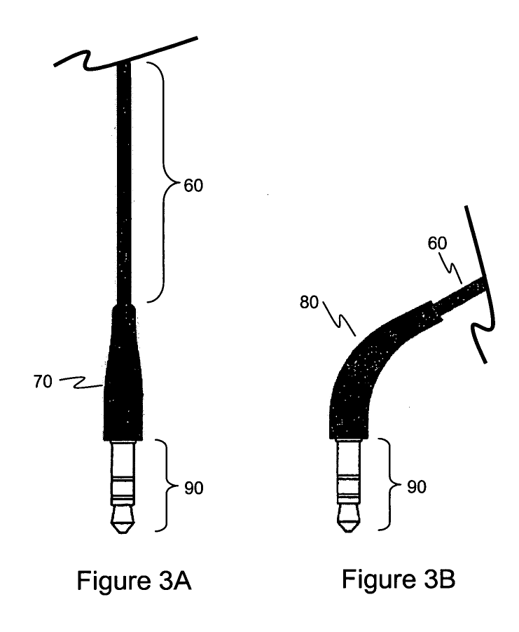

FIGS. 3A and 3B show another embodiment of the present invention, showing two variations of the connecting plug 90. Both illustrations show the speaker cord 60 connecting to a connecting plug sheath, or a curved connecting plug sheath, 70 and 80, respectively. Both the connecting plug sheath 70 and the curved connecting plug sheath 80 cover the connecting plug 90 on one end, so that the connecting plug 90 can be easily inserted and removed in such devices such as CD players and MP3 players. The connecting plug sheath 70/80 may be made of plastic, rubber, and other materials known in the art.

The curved connecting plug sheath 80 is useful for certain audio equipment, for instance, that worn while exercising and strapped to a Velcro™ band around the arm.

It will thus be seen that the embodiments set forth above and those made apparent from the preceding description are efficiently attained and since certain changes may be made in the above construction without departing from the scope of the invention, it is intended that all matter contained in the above description or shown in the accompanying drawings shall be interpreted as illustrative and not in a limiting sense. It is also to be understood that the following claims were intended to cover all of the generic and specific configurations of the invention herein described and all statements of the scope of the invention that as a matter of language might be said to fall therebetween.

1. A pair of earphones including an earphone body, said earphone body comprising:
a speaker cord with at least two separable ends including a first separable end connected to a first speaker, and a second separable end connected to a second speaker;
a docking tail; and
a sliding organizer; wherein
said sliding organizer circumferentially surrounds said speaker cord, said sliding organizer slides between said docking tail and said first and second speakers along said speaker cord, wherein when said sliding organizer is slid to said first and second speakers, said separable speaker cord ends are held together and when said sliding organizer is slid towards said docking tail, said first and second separable ends are separated, thereby allowing a user to place said first and second speakers in different ears.

2. The earphones of claim 1 further comprising speaker bodies for said first and second speakers, wherein said sliding organizer is internally tapered and said speaker bodies are tapered so as to enable said sliding organizer to slide on to said speaker bodies.

3. The earphones of claim 1 wherein an outer sheath of said speaker cord is composed of cloth material.

4. The earphones of claim 1 wherein said sliding organizer comprises plastic, rubber, or metal.

5. The earphones of claim 1 wherein said first and second speakers each include speaker bodies comprising plastic and/or rubber, and said docking tail comprises plastic and/or rubber.

6. The earphones of claim 2 wherein said speaker bodies further comprise ear caps made of silicon and/or rubber.

7. The earphones of claim 1 further comprising a connecting plug covered by a connecting plug sheath.

8. The earphones of claim 7 wherein said connecting plug sheath is curved at an angle that displaces said curved connecting plug sheath from being parallel to said connecting plug at a point where said connecting plug sheath connects to said speaker cord.

9. The earphones of claim 2 wherein said sliding organizer audibly clicks into place upon docking with said docking tail and/or said first and second speaker bodies.

10. A pair of earphones including an earphone body, said earphone body comprising:
a speaker cord with at least two separable ends including a first separable end connected to a first speaker, and a second separable end connected to a second speaker;
a docking tail; and
means for holding together said first and second separable ends of said speaker cord.

11. A method of organizing earphones, wherein said earphones comprise first and second speaker ends, a stereo plug, a sliding organizer, a docking tail, and speaker wire connecting said speaker plug with said speaker ends, and wherein said sliding organizer circumferentially surrounds said speaker wire, the method comprising:
sliding said sliding organizer to said docking tail to place said first and second speaker ends in a usable position; and
sliding said sliding organizer to said first and second speaker ends to bring said first and second speaker ends together.

12. The method of claim 11, wherein said stereo plug includes a cover that is curved, and said method further comprises:
gripping said curved cover for both plugging and unplugging said stereo plug into/from an audio output jack.

13. The method of claim 11, further comprising:
sliding said sliding organizer to beneath a user's chin while the user is wearing said earphones so as to provide a tailored, custom fit for said user.

14. The method of claim 11, further comprising:
clicking said sliding organizer into place on either of said docking tail or said first and second speaker ends, wherein said clicking comprises a vibrational and audible indicator.

15. The earphones of claim 1 wherein an outer sheath of said speaker cord is composed of rubber.

16. The earphones of claim 1 wherein an outer sheath of said speaker cord is composed of silicone.

17. The earphones of claim 1 wherein an outer sheath of said speaker cord is composed of plastic.
